(19) United States
(12) Patent Application Publication
(10) Pub. No.: US 2024/0337752 A1
(43) Pub. Date: Oct. 10, 2024

(54) LIGHT DETECTION AND RANGING SYSTEM WITH DYNAMIC OPTICAL BEAM POWER

(71) Applicant: Toyota Motor Engineering & Manufacturing North America, Inc., Plano, TX (US)

(72) Inventors: Paul Donald Schmalenberg, Ann Arbor, MI (US); Ercan Mehmet Dede, Ann Arbor, MI (US); Danny J. Lohan, Northville, MI (US)

(21) Appl. No.: 18/131,175

(22) Filed: Apr. 5, 2023

(51) Int. Cl. G01S 17/931; G01S 7/48; G01S 17/58

(52) U.S. Cl. CPC G01S 17/931; G01S 7/48; G01S 17/58

(57) ABSTRACT

Systems, methods, and other embodiments described herein relate to dynamic optical beam power for a light detection and ranging system. In one embodiment, a method includes detecting a first object using an optical source activated with a first power level prior to determining to reduce the first power level in response to a first detected vehicle condition. A second power level is then selected to detect a second object using the optical source.

### TECHNICAL FIELD

The subject matter described herein relates, in general, to light detection and ranging (LiDAR) systems and, more particularly, to providing dynamic LiDAR optical beam power to manage thermal load.

### BACKGROUND

Vehicles have consistently added the use of sensors over time to enhance functionality and safety. Sensor technology has advanced to the point where portions of vehicle operation can be conducted autonomously. An industry and consumer emphasis towards making greater portions of a vehicle have autonomous capabilities has tasked vehicle sensors with becoming physically smaller and electrically more sophisticated.

While advancements in semiconductor, processing, and electrical circuitry have made autonomous vehicle capabilities more available, the functional implementation of such circuitry into a vehicle has encountered difficulties. For instance, an ability of a sensor to provide effective cooling of modern circuitry can indicate what types of circuits can be utilized as well as the possible performance of the sensor as a whole. That is, cooling capabilities can determine the amount of power consumption, and the associated heat generation, that can be employed in a sensor, which can correspond with the type, sophistication, and performance of a circuit that can be incorporated into a sensor.

The physical size of a sensor can also be a determining factor in the type and capabilities of sensor circuitry. Although relatively large sensors can experience greater cooling capabilities than small form factor sensors, such large size can be detrimental to the incorporation and/or use of a sensor in a vehicle. Packaging circuitry into a small form factor can provide greater applicability for vehicle use, but can present thermal load challenges, particularly in single circuit packages that employ circuits with different power consumptions and/or temperature sensitivities. Hence, modern vehicle sensors have often compromised sensor size with constituent circuitry capabilities to provide functional sensing in a form factor conducive to vehicle incorporation.

### SUMMARY

In one embodiment, example systems and methods relate to a manner of improving heat control in a light detection and ranging (LiDAR) sensing device.

In one embodiment, a method of of providing dynamic LiDAR power includes detecting a first object using an optical source activated with a first power level prior to determining to reduce the first power level in response to a first detected vehicle condition. A second power level is then selected to detect a second object using the optical source.

In one embodiment, a non-transitory computer-readable medium controlling a light detection and ranging system includes instructions that when executed by one or more processors cause the one or more processors to detect a first object with a first optical beam emitted from an optical source activated with a first power level, decide to reduce the first power level in response to a first detected vehicle condition, and select a second power level to detect a second object using the optical source.

In one embodiment, a LIDAR system has a processor connected to an optical source and a memory storing machine-readable instructions that, when executed by the processor, cause the processor to detect a first object with a first optical beam emitted from an optical source activated with a first power level, decide to reduce the first power level in response to a first detected vehicle condition, and select a second power level to detect a second object using the optical source.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle embodiment within which systems and methods disclosed herein may be implemented.

FIG. 2 illustrates one embodiment of a LiDAR system that can be employed in the vehicle environment of FIG. 1.

FIG. 3 illustrates a block representation of portions of a LiDAR system that can be conducted in accordance with assorted embodiments.

FIG. 4 illustrates portions of the LiDAR system of FIG. 2 operated in accordacne with various embodiments.

FIG. 5 illustrates a flowchart for one embodiment of a routine that may be carried out by a vehicle in some embodiments.

FIG. 6 illustrates a flowchart of an example embodiment of LiDAR system operation.

FIG. 7 illustrates a flowchart of an example routine that can be conducted by a LiDAR system in accordance with various embodiments.

FIG. 8 illustrates aspects of an example LiDAR system executing embodiments in a vehicle environment.

### DETAILED DESCRIPTION

Systems, methods, and other embodiments associated with improving thermal load management in a light detection and ranging (LiDAR) system are disclosed herein. As previously described, an ability to control heat can contribute to the physical size and/or electrical sophistication of a LiDAR sensing device.

In this way, the disclosed systems, methods, and other embodiments improve thermal management by intelligently identifying opportunities to alter optical beam power and subsequently choosing a lowered beam power that accurately detects objects and surfaces.

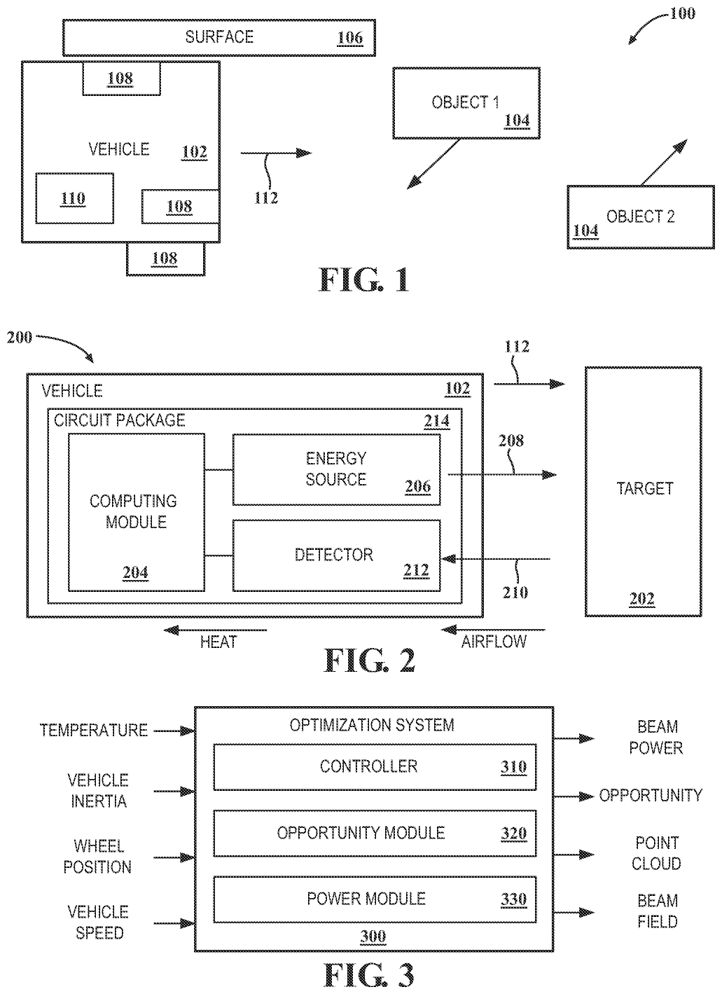

Referring to FIG. 1, an example of an environment 100 is illustrated in which a vehicle 102 can operate to detect objects 104 and surfaces 106 located downrange. As used herein, a “vehicle” is any form of motorized transport. In one or more implementations, the vehicle 102 is an automobile. While arrangements will be described herein with respect to automobiles, it will be understood that embodiments are not limited to automobiles. In some implementations, the vehicle 102 may be any robotic device or form of motorized transport that, for example, includes sensors to perceive aspects of the surrounding environment, and thus benefits from the functionality discussed herein associated with the utilization of LiDAR circuitry employing optimized cooling.

The vehicle 102 also includes various elements. It will be understood that in various embodiments it may not be required or limiting for the vehicle 102 to have all of the elements shown in FIGS. 1-5. The vehicle 102 can have different combinations of the various elements shown in FIGS. 1-5. Further, the vehicle 102 can have additional elements to those shown in FIGS. 1-5. In some arrangements, the vehicle 102 may be implemented without one or more of the elements shown in FIGS. 1-5. While the various elements are shown as being located within the vehicle 102 in FIGS. 1-5, it will be understood that one or more of these elements can be located external to the vehicle 102. Further, the elements shown may be physically separated by large distances.

It is noted that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In either case, the vehicle 102 includes a LiDAR system that employs a circuit package with dynamic cooling that allows for optimized performance in a reduced physical form factor.

The incorporation of sensors 108 into the vehicle 102 can allow for increased autonomy as information about the vehicle 102, area immediately around the vehicle 102, and area downrange of the vehicle 102 are collected an processed by a vehicle processor 110. While shown as an on-board vehicle component, it is noted that processing and other computing capabilities can be conducted away from the vehicle 102 and communicated to on-board computing circuitry 110, such as a processor, controller, memory, cache, or programmable circuitry, via one or more data wireless pathways.

Assorted sensors 108 of the vehicle 102 can operate continuously, sporadically, or randomly to collect information about one or more aspects of the vehicle 102, downrange objects 104, and downrange surfaces 106. It is noted that the term “downrange” can be characterized as any direction and distance that is separated from the vehicle 102. For instance, an object 104, or surface 106, that is positioned to one lateral side, in front of, or behind a vehicle 102 can each be downrange of a sensor 108, particularly a sensor 108 emitting energy and detecting return energy to identify at least the position of the object/surface.

A vehicle sensor array can consist of any number and type of sensor 108, which may be arranged to provide redundant, or unique, measurements that detect common, or dissimilar, types of information. For example, a first sensor 108 can be a LiDAR sensor that emits energy beams with optical range wavelengths to detect downrange objects 104 and surfaces 106 while a second sensor 108 is a camera, acoustic detector, or temperature detector that collectively sense the presence of downrange objects 104 and surfaces 106 with energy beams having non-optical range wavelengths.

The detection of aspects of the field of view downrange of the vehicle 102 can be complicated by the movement of one or more objects 104, as conveyed by solid arrows. The combination of stationary downrange aspects, such as a surface 106, along with objects 104 moving in different directions, and at potentially different velocities, further complicate the accurate detection and identification of the downrange environment. Movement of the vehicle 102, as conveyed by solid arrow 112, can add an additional layer of complexity to object 104 and surface 106 detection, particularly in a time horizon that involves computer processing of collected information to identify where, and how, the vehicle 102 can travel through the downrange environment safely.

With reference to the block representation of a LiDAR system 200 in FIG. 2. embodiments are illustrated that can individually, or collectively, be employed in the environment 100 of FIG. 1. Although not required or limiting, FIG. 2 conveys a single sensor 108 that is integrated into, or onto, a vehicle 102. The sensor 108 can employ any number, type, and function of circuitry that allows fast and accurate detection of a target 202 positioned at any distance downrange of the vehicle/sensor.

The example LiDAR system 200 shown in FIG. 2 employs optimization system 204. such as a memory, microprocessor, controller, or other programmable circuit, to operate at least one energy source 206 to emit beam(s) 208 with energy in a selected frequency and wavelength range, such as an optical range, that bounce off downrange targets 202 and return as energy 210 that is sensed by a one or more detector 212. The collection of information about emitted energy 208 and return energy 210 allows the optimization system 204 to process the data to determine the shape, size, and velocity of the target 202 as well as the distance to the target 202.

In an effort to provide fast and accurate operation, the operating temperature of various components can be prioritized by providing ample airflow to, and around, the circuitry of at least the energy source 206 and detector(s) 208. Such airflow is often facilitated by separating components with space and/or static cooling members, such as fins, sinks, or coatings, which increases the overall physical size and form factor of the sensor 108.

The addition of the optimization system 204 to a sensor 108 can further complicate cooling, and increase sensor size, by providing a different peak performance operating temperature range than the circuitry of the other sensor circuitry. That is, different circuits can generate different amounts of heat and have heat dissipation capabilities that cause sensor 108 designs to compromise between higher performance and physical size due to physically larger sizes providing greater performance consistency and less operational temperature variability. Accordingly, various embodiments are directed to dynamic cooling for a LiDAR sensor to allow high computing and detection capabilities to operate in a relatively small form factor, such as a single sensor 214 consisting of multiple separate circuits.

FIG. 3 illustrates a block representation of portions of an example optimization system 300 that can be employed in as part of a LiDAR sensor to provide optimized beam power selection in response to an identified, or predicted, opportunity to utilize reduced beam power. Any number of inputs can be used by local, or remote, optimization system 310, such as a controller, microprocessor, or other programmable circuit, to determine at least when reduced laser power can be employed, the power value that can provide accurate downrange detection, the field of view for beam dispersion, and the point cloud of beam dispersion to identify assorted downrange objects, surfaces, and targets. It is contemplated that the optimization system 310 utilizes one or more predetermined algorithms to translate input information into the various aspects that result in a customized laser power beam and beam dispersion across a field of view.

The assorted input information can be obtained from any number, type, and position of sensors inside and/or outside the vehicle. While not required or limiting, various vehicle information can provide the optimization system 300 with data indicating the current status of the environment around the vehicle as well as the future detection needs to understand changing environmental conditions. For instance, one or more sensors can convey vehicle speed, vehicle inertial measurements, and vehicle wheel position to the optimization system 300 to identify areas in a field of view of a LiDAR sensor that are important and which areas can be safely ignored. That is, assorted vehicle data can allow the optimization system 300 to determine what areas in a field of view are ripe for beam customization, can be ignored with no beam detection, and are important enough for full power beam analysis.

The optimization system 310 can engage one or more local, or remote, memories that store assorted temporary, and permanent, data. For instance, a memory of the optimization system 300 can store input vehicle data, model data from other vehicles, opportunities to reduce optical source power, custom reduced beam power levels, point clouds, and beam fields. The memory can operate in conjunction with the controller aspects of the optimization system 310 to efficiently carry out assorted routines and processes to translate detected vehicle and driving conditions into opportunities to utilize reduced optical source power to accurately detect objects. It is noted that the various modules of the optimization system 300 can be resident physically as circuitry or as computer instructions stored in the memory.

Some embodiments of the optimization system 300 include a memory that stores an opportunity module 320 and a power module 330. The modules 310 and 320 are, for example, computer-readable instructions that when executed by the controller 310 cause the controller 310 to perform the various function disclosed herein. The opportunity module 320 generally includes instructions that function to control the controller 310 to receive data inputs from one or more sensors of the vehicle 102. The inputs are, in one embodiment, observations of one or more objects in an environment proximate to the vehicle 102 and/or other aspects about the surroundings. As provided for herein, the opportunity module 320, in one embodiment, acquires sensor data that includes at least camera images. In further arrangements, the opportunity module 320 acquires the sensor data from further sensors such as a radar, a LiDAR, or other sensors as may be suitable for identifying vehicles, conditions, and locations of other vehicles.

The opportunity module 320 of the system 300 can rank various areas of a field of view by safety and/or performance opportunity to customize optical beam analysis and target detection. Hence, the opportunity module 320 can identify both instances where customized laser power can be utilized to accurately detect objects, surfaces, and targets as well as instances where optical detection beams can be turned off due to an identified low risk of any targets that could impact the safety of a vehicle. In other words, the opportunity module 320 can operate alone, or in combination with the module optimization system 310, to segment a LiDAR sensor's field of view into regions that need more, or less, accuracy now and in the near future in response to a safety risk of each region assigned by the system 300.

The opportunity module 320 may further analyze various temperature readings to determine the current thermal load on a LiDAR circuit package as well as predict future temperatures based on the cooling capabilities of the circuit package. Any number and location of temperatures can be obtained concurrently or sequentially, such as ambient air temperature, vehicle engine temperature, circuit package temperature, or individual circuit temperature of the circuit package. Obtaining the current temperature of various aspects of a vehicle environment allows the optimization system 300 to factor current and predicted future thermal load into the customization of optical beams for identified opportunities.

The power module 330, in one embodiment, generally includes instructions that function to control the controller 310 or collection of processors of the optimization system 300 to correlate known cooling capabilities of assorted aspects of a vehicle and/or LiDAR circuit package to determine a power consumption budget for at least a laser to maintain the circuit package in a predetermined temperature range that corresponds with peak performance. The power module 330 can utilize any number and type of current and predicted vehicle and LiDAR circuit package conditions, such as vehicle speed and expiration of a full power optical scan, to customize power consumption of a laser of the LiDAR circuit package for one or more beams of a beam field to optimize the cooling capabilities of at least the circuit package to maintain operation within a peak performance temperature range. Use of the power module 330 to choose laser power with regard to thermal load and cooling capabilities ensures opportunities identified by the opportunity module 320 to use reduced optical beam power will result in laser power consumption that is customized to maintain peak circuit operation. In contrast, customizing laser power without regard for current, or predicted, thermal load as well as the cooling capabilities of a LiDAR circuit package could result in a reduction in thermal load that is insufficient, based on the cooling capabilities associated with the predicted vehicle speed, to maintain the circuit package in a peak performance operating temperature.

The assorted aspects of the optimization system 300 can respond to current, and predicted, opportunities to use reduced laser power to detect downrange objects, surfaces, and targets by creating a custom point cloud that uses selected beam locations and power to efficiently and safely understand the environment around a vehicle without producing undue thermal load on at least the LiDAR circuit package. That is, the optimization system 300 can respond to an opportunity identified by the opportunity module 320 by altering the number and/or power of beams directed at a particular object, surface, or target, which can reduce the overall number of beams generated by a circuit package. For instance, a road surface that is detected with a relatively high number of beams during a full power scan can be customized to a lower number of beams in response to the road being identified as consistent and a low risk of changing over time. It is contemplated a customized point cloud can update and adapt over time in response to changing thermal loads, circuit temperatures, or downrange objects to be identified.

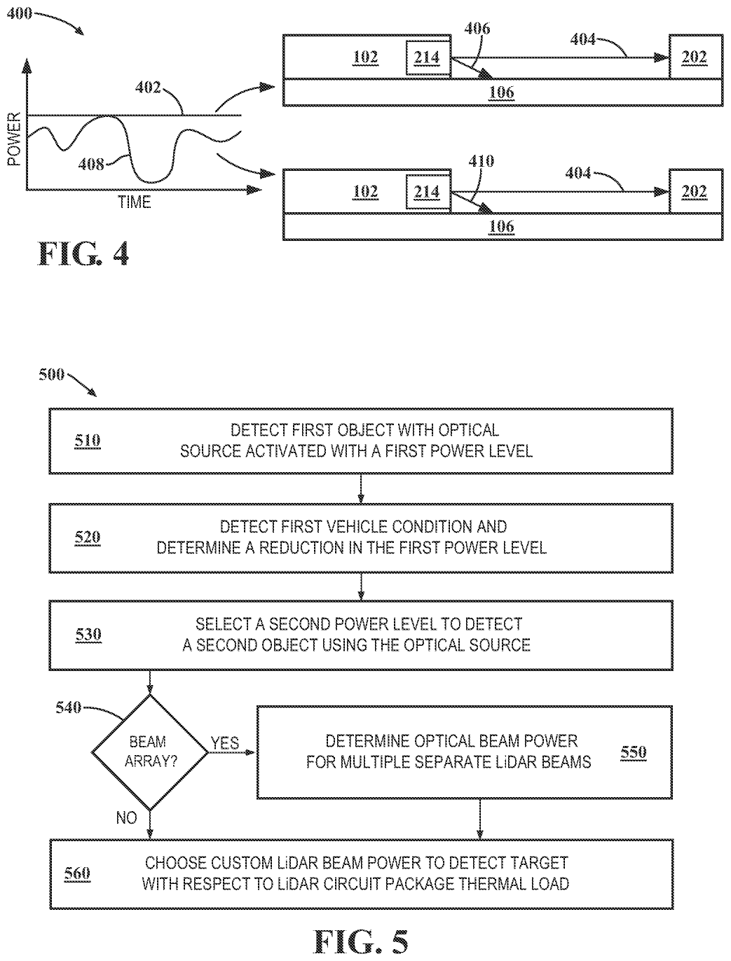

FIG. 4 illustrates aspects of an example LiDAR system 400 operated in accordance with some embodiments. The plot of laser power over time corresponds with data from different operational embodiments, shown as block representations where a vehicle 102 travels along a road surface 106 with another downrange target 202. The static use of laser power, as conveyed by line 402, is associated with a common laser power being applied to all beams 404/406, regardless of direction of beam travel, type of target 202/206, or conditions of the vehicle 102.

As a result of using a common laser power, the maximum detection accuracy of the LiDAR sensor 214 when the sensor 214 is within peak operating performance ranges, such as temperature and power consumption. However, the cooling capability of the circuit package 214, and/or vehicle 102, may not be sufficient to sustain the sensor 214 within peak operating performance range, particularly when the vehicle 102 is not moving to induce convective cooling in the sensor 214.

The operational chart conveys how a static beam power over time compares to employing intelligently chosen beam power, as shown by line 408. The intelligent identification of opportunities to reduce laser power without degrading effective accuracy of the LiDAR sensor 214. That is, the LiDAR sensor 214 can identify when a downrange object, surface, and/or target can be accurately detected with a laser power that is less than a maximum power, such as the common/default power illustrated by line 402. The LiDAR sensor 214 may further react to an identified opportunity by intelligently selecting a laser power that provide sufficient detection accuracy and speed within predetermined specifications while controlling the thermal load of the sensor 214.

The non-limiting block representation of the intelligent identification of a reduced laser power opportunity, selection of laser power to reduce thermal load, and use of reduced laser power to detect downrange aspects is conveyed by laser beam 404 having a common/default laser power while beam 410 originating from a reduced laser power is directed at a consistent and known surface 106, such as a road. It is noted that separate optical beams may be emitted from the LiDAR sensor 214 at different angles relative to the package and vehicle to collect information about downrange targets 202 and surfaces 106. Such separate optical beams can be emitted concurrently, sequentially, and randomly to identify size, position, direction of travel, and velocity of one or more downrange aspects.

Through the ability to detect objects, surfaces, and other targets with sufficient accuracy and less than full laser power, the overall amount of power consumption and corresponding heat in the LiDAR sensor 214 can be decreased over time, as shown by the operational data of the graph in FIG. 4.

The laser power that produces an optical beam 404/406/410 can correspond with a distance the resulting optical beam will accurately detect objects/surfaces. That is, an optical beam produced by a laser with reduced power can accurately detect targets, just not as far downrange and/or with the resolution to make sophisticated determinations, such as velocity or size, compared to optical beams resulting from maximum laser power. Hence, objects, surfaces, and other targets can be detected with sufficient accuracy and speed by less than full laser power if they are within a predetermined distance from the LiDAR sensor 214. Accordingly, various embodiments of a LiDAR sensor 214 identify a reduced laser power opportunity when downrange aspects are, or will be, within a distance threshold.

Other embodiments of a LiDAR sensor 214 involve reducing laser power in response to an identified opportunity where a downrange aspect is known and consistent. For example, a stationary rail, road surface, or sign may receive less laser power after an identification of the object or surface as an opportunity to know the environment around a vehicle 102 without employing full, or a higher default, laser power. In other words, an opportunity can be characterized as an event when reduced power can provide sufficient accuracy to understand the environment surrounding the vehicle.

It is contemplated that an identified opportunity to reduce power may result in no beam at all for areas that the LiDAR package identifies as inconsequential, such as aerial objects or stationary objects. The identification of an opportunity to use zero laser power can, in some embodiments, consider the temperature of the LiDAR sensor 214 and/or the autonomous activity of the vehicle 102. For instance, a relatively high thermal load in the sensor 214 or active autonomous vehicle activity may cause identified opportunities to use reduced laser power to be further evaluated by the sensor 214 to determine if a zero laser power would provide above a minimum level of safety for the vehicle 102. Hence, various embodiments of the LiDAR system 400 conduct intelligence to identify opportunities to reduce power and to subsequently select an optical source power level that provides optimized thermal management without sacrificing downrange detection accuracy or safety.

Additional aspects of the optimization system 300 will be discussed in relation to FIG. 5. FIG. 5 illustrates a flowchart of a method 500 that is associated with LiDAR beam customization. Method 500 will be discussed from the perspective of the optimization system 300 of FIG. 3. While method 500 is discussed in combination with the optimization system 300, it should be appreciated that the method 500 is not limited to being implemented within the optimization system 300, but is, instead, one example of a system that may implement the method 500.

At step 510, the opportunity module 320 and/or power module 330 detect a first object using an optical source activated with a first power level to emit a first optical beam. The first power level, in some embodiments, can be characterized as a default optical source power. It is contemplated, but not required, that the first power level of step 510 is a maximum optical source, such as a laser, power. The first power level can correspond with an optical beam range that can identify various characteristics of an object, surface, or other target, such as size, position, motion, direction, and velocity. The detection of various aspects downrange from a LiDAR circuit package in step 510 can be conducted any number of times and for any duration.

At some point after the LiDAR system operates to detect at least one downrange object in step 510, step 520 detects a first vehicle condition and determines a reduction in the first power level in response to the detected first vehicle condition with the opportunity module 320 alone, or in combination with the power module 330. The module 320/330 of the optimization system, in step 520, can identify an opportunity in response to the detected vehicle condition to accurately detect a target with a beam power that is less than the first power level used in step 510. In other words, the modules 320/330, in step 520, evaluates detected objects and surfaces to determine when a reduced optical source power can reliably detect future downrange targets. Such an opportunity may detect a common surface, such as a road or building, or detect a different object with the same orientation relative to the LiDAR sensor, such as the same distance, angle, or elevation. The discovery of an opportunity to use reduced power to detect a downrange aspect prompts the power module 330 in step 530 to select a second power level to detect a second object using the optical source. The selection of the second power level may take advantage of the opportunity and conduct accurate downrange detection with mitigated power consumption and generation of LiDAR circuit package heat.

It is noted that the intelligent selection of beam power by the power module 330 in step 530 can have a variety of different themes that reflect a balance of LiDAR sensing accuracy and circuit package thermal load. The customization of a LiDAR beam via the power module in step 530 can respond to the opportunity module 320 identifying an opportunity by reducing laser power, but can involve altering other beam characteristics, such as resolution and timing. Through the customization of beam power through optical source power level selection in step 530, downrange detection of objects can be balanced with heat generated by LiDAR sensor circuitry, which provides a LiDAR sensor with optimal power consumption that can accommodate a diverse range of cooling conditions, such as a stationary vehicle, high ambient temperature, or high direct ultraviolet light, conditions.

Some embodiments cycle operation of the power module 330 by executing step 530 over time to select diverse optical source power levels for different beams individually. Other embodiments consider customizing an array of beams with portions of the optimization system 300 in decision 540. It is contemplated, but not required, that the optimization system considers, in decision 540, the processing capabilities of a LiDAR circuit package with respect to current and/or predicted future demands to determine if multiple separate optical beams can be customized to reduce power consumption and heat generation without degrading downrange detection accuracy or speed. If so, the power module 330, in step 550, customizes a beam array by altering at least two beams from a default laser power, such as from the first optical source power level. The customization of step 550 with the power module 330 may have similar evaluations and results as step 530, but with the additional evaluation of identified opportunities in a field of view of a LiDAR sensor as well as how the collective power consumption, and corresponding heat generated during beam array emission, impacts the operating temperature of the LiDAR circuit package.

Once a custom beam power is chosen with the power module 330 for a single beam in step 530, or for multiple beams in step 550, the power module 330, in step 560, proceeds to emit a continuous, or sporadic, beam with the chosen amount of power, which corresponds with the amount of electrical energy supplied to a laser of a LiDAR circuit package. The reduced power of one or more beams then reacts to encountered downrange surfaces and objects to return energy that is detected by the LiDAR circuit package. The various aspects of the beam customization routine 500 can be conducted any number of times and in any sequence that is selected by the intelligence of the local, or remote, computing circuitry utilized by the LiDAR circuit package.

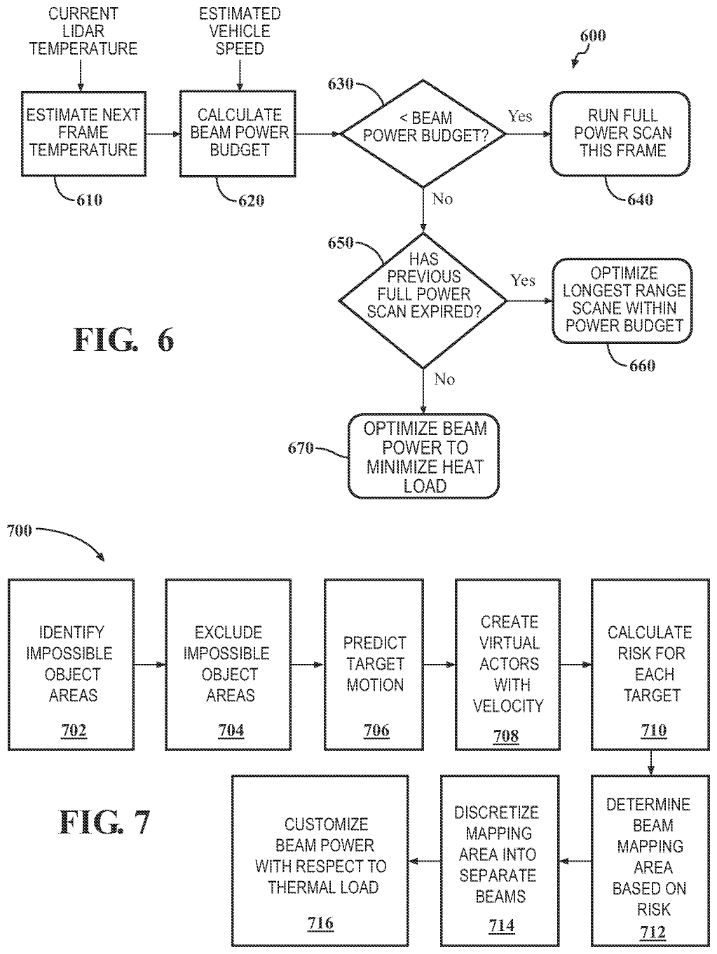

FIG. 6 illustrates a flowchart of an example power budget routine 600 that can be carried out by assorted embodiments of a vehicle employing a LiDAR sensor and optimization module. The routine 600 can operate as part of step 560 of routine 500 to choose custom optical source beam powers with respect to thermal load. Based on one or more input variables detected by at least one sensor, a temperature of some, or all, of a LiDAR sensor is predicted in step 610. It is contemplated that more than one temperature over time can be predicted by the computing circuitry of the optimization module for any amount of time in the future, such as the next second, minute, or millisecond.

The prediction of the future temperature of a LiDAR package as a whole, or of a single constituent package circuit in step 610 allows the optimization module to calculate an optical source beam power budget for the circuit package in step 620, based on the cooling capabilities of the package for a known, or predicted, vehicle speed, that maintains a package circuit, or the package as a whole, at an operating temperature that is within a known operating range that allows peak, or maximum, performance, such as accuracy, speed, and/or efficiency. The calculated laser power budget from step 620 can prescribe one or more threshold power consumption values for instantaneous use or average use over a set timeframe, such as a second, ten seconds, or a minute.

At any time after the calculation of a power budget with one or more threshold power consumption thresholds in step 620, decision 630 evaluates current and/or average power consumption for a LiDAR circuit package compared to the provided thresholds. If power consumption is safely below an established threshold, meaning there is room to provide power to a laser, a full power scan of at least a portion of a field of view of the LiDAR circuit package is undertaken in step 640. In other words, the understood availability to expend laser power and remain within the set power budget allows the optimization module to conduct step 640 and prioritize safety and accuracy of vehicle environment detection.

It is noted that a full power scan may involve laser sourced beams with default, which may be the maximum possible, power emitted concurrently, or sequentially, across a selected field of view with a selected resolution. For instance, a relatively large availability of power consumption to stay below a set threshold and budget may involve concurrently emitting beams with maximum laser power with a relatively tight resolution, such as every foot or inch, while lower available amounts of power may sequentially stream beams in a full power scan with a relatively loose resolution, such as two feet or ten feet.

In the event the optimization module determines that the current, and/or predicted, power consumption is above one or more established thresholds, meaning there is little, or no available power for the laser to operate without risk of exceeding the power budget and circuit package thermal load, decision 650 is conducted to evaluate the age of the last full power scan. It is contemplated that the optimization module sets an expiration time for a full power scan based on the results of the scan itself, vehicle conditions, and predicted LiDAR circuit package thermal load. As an example, a full power scan can be assigned a short expiration duration in response to a fast vehicle speed or frequent occurrence of risk conditions, such as traffic, intersections, or low visibility while a full power scan may be assigned a long expiration duration in response to a slow vehicle speed or consistency of detected aspects, such as road, curves, and elevation, over time.

A determination, in decision 650, that a full scan has expired, or is going to expire soon, triggers step 660 to calculate and execute a supplemental scan with a greatest range within existing power and thermal budget. That is, step 660 compromises with an expired, or nearly expired, full scan by focusing remaining power budget to detect objects, surfaces, and targets as far from the vehicle as possible, which provides the most time to cool the LiDAR circuit package and regain thermal/power budget to conduct a comprehensive full scan. Some embodiments of step 660 prescribe a supplemental long-range scan with a custom resolution that allows a greater range of a field of view to be scanned or an identified area of risk or interest to be scanned more completely with the remaining thermal/power budget.

From decision 650 determining that an existing full scan is valid and unexpired, step 670 employs the remaining power budget to customize one or more optical beams to minimize thermal load on a LiDAR circuit package without sacrificing detection accuracy. Hence, step 670 prioritizes thermal load management and circuit package operating temperatures by responding to identified opportunities with reduced laser power, beam field resolution, or both. It is contemplated that the customization of optical beams in step 670 can involve altering the timing of various optical beams in a beam field to reduce the overall power consumption and associated heat generation.

With the ability to utilize logged results and model data to predict future temperatures, cooling, power consumption, and thermal load, an optimization module can generate a power consumption budget with thermal thresholds that can guide how beams and beam fields are customized over time to mitigate overheating and degraded operational performance due to high LiDAR circuit package temperature. The prediction of future conditions can be extended by the optimization module, in some embodiments, to forecast possible objects and motion.

FIG. 7 illustrates a flowchart of an example virtual actor routine 700 that can be conducted with assorted embodiments of the optimization system 300 as part of a LiDAR sensor included in part of a vehicle. The routine 700 may further optimize step 560 of routine 500 by taking into account predicted obstructions and safety hazards into optical source power selection. The routine 700 can begin with the optimization system of an optimization system of a LiDAR sensor identifying, in step 702, one or more areas of a field of view as impossible for new objects to obstruct vehicle movement or otherwise pose a safety risk to a vehicle, such as from the sky, from behind, from below a vehicle, or from the immediate lateral sides of the vehicle.

The identification of portions of a field of view allows an optimization module to subsequently exclude the identified areas in step 704 from consideration of any virtual actors, such as vehicles, people, animals, or moving objects. That is, step 704 can ignore existing aspects resident in regions identified in step 702 as well as any virtual actors predicted to be resident in the impossible areas. The reduction in the field of view to analyze allows the optimization module to focus computing power on predicting motion of existing, detected targets in selected field of view regions in step 706 and the generation of virtual actors that are not actually detected in selected field of view regions in step 708.

The generation of virtual actors in step 708 can involve the prediction of the location, motion, and velocity of any number, and type, of virtual actor in an area of a vehicle's field of view deemed possible by the optimization module. For instance, step 608 can generate actors that are not actually detected, but are possible based on the detected environment, such as around a blind corner, intersection, wall, building, or large vehicle. The generation of virtual actors with possible velocity allows the optimization module to calculate a vehicle safety risk for each virtual actor in step 710. That is, step 710 can utilize previously logged target behavior and/or theoretical model data for target behavior to determine how likely a virtual actor is to obstruct vehicle travel in view of current vehicle condition and/or predicted future vehicle travel, such as turns, braking, acceleration, or lane changes.

The risk evaluation of step 710 may, in some embodiments, further involve evaluation of the ability of the vehicle to evade the virtual actor. For instance, the vehicle risk of step 710 can correspond with how likely a virtual actor is to obstruct a vehicle, how much vehicle damage impact with a virtual actor would inflict, and/or the chance a vehicle could avoid a virtual actor based on existing vehicle status and predicted vehicle capabilities. In response to the virtual actor risk calculated in step 710, an optimization module can configure an optical beam field that mitigates detected target risk and virtual actor risk. In other words, step 712 determines what optical beam position, range, and resolution, which can be characterized as a beam map, provides the optimal use of power/thermal budget for a LiDAR circuit package to detect possible objects that pose a safety risk.

The customization of the beam map in step 712 allows the optimization module to effectuate the map with separate optical beams directed to discretized portions of the map. The map from step 712 along with the separate optical beams of step 714 can be emitted with common beam characteristics in selected areas in accordance with some embodiments. Such common beam characteristics can provide heightened risk mitigation and vehicle safety by disregarding the thermal load of a LiDAR circuit package. That is, step 714 can produce optical beams with full laser power directed at areas deemed risky to provide the greatest possible detection speed and accuracy of real, and virtual, targets that pose a threat to a vehicle.

However, the use of common, full power, optical beams is not required or limiting as other embodiments execute step 716 to customize one or more laser beam parameters to balance the detection of downrange aspects, detection of virtual actors, and generation of heat in a LiDAR circuit package. Accordingly, an optimization module, in step 716, may create individually customized optical beam parameters, such as power and timing, to balance laser power consumption, and corresponding heat generation, with the calculated risk posed by detected targets and potentially detected virtual actors.

It is noted that the customization of optical beams can conform to a theme. That is, beams can have a customized resolution and area according to the beam map of step 712 and customized beam source power and timing according to the power budget themes conveyed in FIG. 6. For instance, step 716 can prioritize safety with frequent full power scans, can prioritize heat mitigation with beam power reductions, or can compromise with utilizing laser power budget to provide full power to less than all the optical beams of a beam map/field. As a result of the actions of routine 700, greater risk equates to more laser power, and generated heat, being dedicated to field of view regions where existing, and/or virtual actors, can pose a risk to vehicle safety.

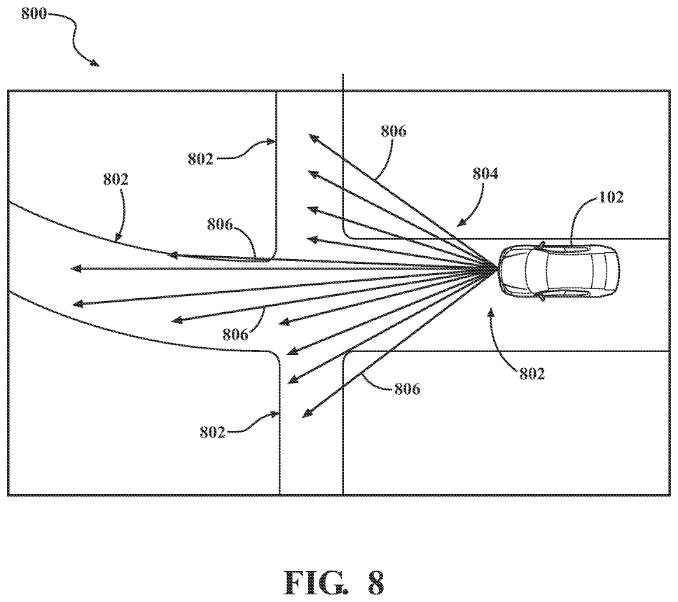

FIG. 8 illustrates a top view of portions of a vehicle environment 800 employing a LiDAR sensor consisting of the optimization system 300 of FIG. 3. As the vehicle 102 traverses a road 802, the LiDAR sensor balances optical beam range with thermal load to provide a safe evaluation of the elevation, objects, and surfaces with the selected field of view of the LiDAR sensor. For instance, a high thermal load and relatively slow vehicle speed may cause the optimization module to reduce the range of some, or all, of the LiDAR beams emitted from the sensor as part of a point cloud to roughly identify the presence of objects and targets in front of the vehicle 102. Conversely, high cooling capability due to cool ambient air, sustained headwind, and/or relatively fast vehicle 102 movement can prompt the optimization module to increase the range of some emitted optical beams as part of a point cloud that detects that objects and/or targets are in front of the vehicle 102 and are in need of further optical investigation to determine the size, direction of travel, and/or velocity.

As a non-limiting example, the LiDAR sensor can react to when the vehicle is going to make a turn, climb a slope, or descend a grade by customizing the field of view 804, number of optical beams 806 concurrently emitted, and/or beam range to increase the ability to quickly and accurately detect partially, or wholly, hidden objects, surfaces, and other targets that could interfere with the vehicle's progression down the road 802. For any reason, the optimization module can decide to customize the beam field shape, size, or range by customizing one or more constituent optical beams 806.

As illustrated by the top view of FIG. 8, customization of optical beams 806 can provide a diverse array of laser powers, as indicated by distance from the vehicle 102. Through the intelligent customization of laser power, various important aspects can receive more optical beam attention, such as with greater beam resolution and/or beam power, while aspects deemed of less importance to the safety and/or function of the vehicle 102 receive lower beam resolution and/or reduced beam power/range. The ability to customize not only the power of a single beam, but the shape and size of an entire beam field, with respect to current vehicle and LiDAR circuit package, as well as predicted future conditions, allows for intelligent reduction in laser power consumption and LiDAR circuit package thermal load without degrading optical detection or vehicle safety.

It is noted that portions of the possible field of view from the vehicle 102 do not receive an optical beam 806, which can correspond with an identified opportunity to ignore an angle from the vehicle 102, a particular object, or a surface. The non-limiting example of FIG. 8 conveys how the optimization module identifies an intersection of roads 502 and directs several separate beams 806 along the intersecting road 802 in response to identification that objects are likely to travel along the road 802 towards the vehicle 102 and/or the future travel path of the vehicle 102. Thus, the optimization module can identify a high risk condition, such as a blind corner or intersection, and customize beam field and/or beam power to maintain vehicle safety, particularly during autonomous vehicle activity, while mitigating power consumption and heat generation.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-8, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, modules as used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality.” as used herein, is defined as two or more than two. The term “another,” as used herein, is defined as at least a second or more. The terms “including” and/or “having.” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A method comprising:
detecting a first object using an optical source activated with a first power level;
determining to reduce the first power level in response to a first detected vehicle condition; and
selecting a second power level to detect a second object using the optical source.

2. The method of claim 1, wherein the second power level corresponds with a reduced heat generation by the optical source compared to the first power level.

3. The method of claim 1, wherein the second power level corresponds with detection of a distance from the optical source to the second object.

4. The method of claim 1, further comprising activating the optical source with the second power level to detect a velocity of the second object.

5. The method of claim 1, wherein the first detected vehicle condition is a thermal load condition in a package containing the optical source, the thermal load condition corresponding with a temperature of the optical source exceding a predetermined threshold.

6. The method of claim 1, wherein selecting the second power level is based on a second detected vehicle condition, the second detected vehicle condition being different than the first detected vehicle condition.

7. The method of claim 6, wherein the first detected vehicle condition is a vehicle speed and the second detected vehicle condition is a vehicle wheel position.

8. A non-transitory computer-readable medium for controlling a light detection and ranging system and including instructions that when executed by one or more processors cause the one or more processors to:
detect a first object with a first optical beam emitted from an optical source activated with a first power level;
decide to reduce the first power level in response to a first detected vehicle condition; and
select a second power level to detect a second object using the optical source.

9. The non-transitory computer-readable medium for controlling a light detection and ranging system of claim 8, wherein the second power level consumes less electrical power than the first power level.

10. The non-transitory computer-readable medium for controlling a light detection and ranging system of claim 8, wherein the first object is positioned at a farther distance from the optical source than the second object.

11. The non-transitory computer-readable medium for controlling a light detection and ranging system of claim 8, wherein the second object is detected with a second optical beam emitted form the optical source.

12. The non-transitory computer-readable medium for controlling a light detection and ranging system of claim 8, wherein the second power level corresponds with a detection distance from the optical source to the second object.

13. A system comprising:
a processor connected to an optical source;
a memory storing machine-readable instructions that, when executed by the processor, cause the processor to:
detect a first object with a first optical beam emitted from an optical source activated with a first power level;
decide to reduce the first power level in response to a first detected vehicle condition; and
select a second power level to detect a second object using the optical source.

14. The system of claim 13, further comprising identify a region of a field of view of the optical source that poses a reduced safety threat for a vehicle containing the optical source; and ignore the region by deactivating the optical source when pointed toward the region.

15. The system of claim 13, further comprising identify an area of a field of view of the optical source posing a risk of containing an object that could obstruct travel of the optical source; and create a virtual actor in the area used to calculate a risk a third object will obstruct travel of the optical source.

16. The system of claim 15, wherein the area of the field of view has aspects hidden from the optical source.

17. The system of claim 15, wherein the area of the field of view is an intersection, hill, or wall.

18. The system of claim 15, further comprising predicting motion of the virtual actor relative to the optical source and using the motion to calculate the risk the third object will obstruct travel of the optical source.

19. The system of claim 15, further comprising selecting a third power level to emit towards the area of the field of view in response to the risk, the third power level being greater than the second power level.

20. The system of claim 15, further comprising selecting the second power level based on a predicted thermal load of the optical source.
